(19) United States
(12) Patent Application Publication
(10) Pub. No.: US 2007/0063643 A1
(43) Pub. Date: Mar. 22, 2007

(54) Plasma display panel

(76) Inventors: Tae-Seung Cho, Suwon-si (KR); Yong-Shik Hwang, Suwon-si (KR); Won-Seok Yoon, Suwon-si (KR); Tae-Jung Chang, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/517,764

(22) Filed: Sep. 8, 2006

(30) Foreign Application Priority Data
Sep. 8, 2005 (KR) 10-2005-0083672

(51) Int. Cl. H01J 1/62

(52) U.S. Cl. 313/506

(57) ABSTRACT

A plasma display panel having an opposed discharge structure that can improve discharge efficiency is disclosed. The plasma display panel includes a first substrate and a second substrate arranged to face each other with a predetermined space therebetween, and having a plurality of discharge cells defined in the space between the first and second substrates; phosphor layers formed inside the respective discharge cells; address electrodes formed to extend along a first direction on the second substrate; first and second electrodes formed to extend along a second direction intersecting the first direction, between the first and second substrates and projecting toward the first substrate in a direction away from the second substrate, the first and second electrodes facing each other with a space therebetween; and third and fourth electrodes formed along the second direction between the first substrate and the second substrate, and separated from the respective first and second electrodes in a direction substantially perpendicular to the second substrate.

### CROSS-REFERENCE TO RELATED APPLICATION

This application claims priority to and the benefit of Korean Patent Application No. 10-2005-0083672 filed in the Korean Intellectual Property Office on Sep. 08, 2005, the entire content of is are incorporated herein by reference.

### BACKGROUND OF THE INVENTION

1. Field of the Invention

The present embodiments relate to a plasma display panel (PDP), and more particularly, to a plasma display panel having an opposed discharge structure that can improve discharge efficiency.

2. Description of the Related Art

In general, a PDP is a display device that realizes an image using visible light generated by exciting phosphors with vacuum ultraviolet (VUV) rays radiated by plasma obtained by the discharge of a gas. A PDP with a display screen of 60 inches or more can be realized with a thickness of 10 cm or less. Since the PDP is a self-emitting display device like a cathode ray tube (CRT), it provides outstanding color reproducibility and no distortion caused by viewing angles. Further, since the PDP may be manufactured easier than a liquid crystal display (LCD) panel, it may have higher productivity and lower manufacturing costs. Thus, the PDP has been spotlighted as a next-generation industrial flat panel display and a home TV display.

The structure of a PDP has been developed over a long period of time since the 1970's. The most common structure is a three-electrode surface discharge structure. The three-electrode surface discharge type structure includes one substrate having two electrodes disposed on the same plane, and another substrate that is separated therefrom by a predetermined gap and has address electrodes extending in a substantially perpendicular direction. A space formed between the two substrates is filled with a discharge gas and sealed.

Generally, the discharge of the PDP is determined by the discharge of the address electrodes connected to each line and the scan electrodes facing the address electrodes, and is independently controlled. A sustain discharge for displaying a luminance is generated by two electrode groups, i.e., the sustain electrodes and the scan electrodes, which are formed on the same substrate.

Once the discharge is generated between the sustain electrodes and the scan electrodes, a voltage distribution between the sustain electrodes and the scan electrodes is distorted due to a space charge effect occurring in a dielectric layer around the cathode and the anode. More specifically, in an AC three-electrode surface discharge structure, the sustain electrodes and the scan electrodes serve as a cathode and an anode in an alternating manner according to an input voltage pulse, and a voltage distribution between the cathode and the anode is distorted.

In other words, a cathode sheath region is formed in the vicinity of the cathode, an anode sheath region is formed in the vicinity of the anode, and a positive column region is formed between the two regions. Most of the voltage applied to the two electrodes for generating the discharge is consumed in the cathode sheath region, a portion of the voltage is consumed in the anode sheath region, and little voltage is consumed in the positive column region. Electron heating efficiency depends on a secondary electron coefficient of an MgO protective film formed on the surface of the dielectric layer in the cathode sheath region. Most of the input voltage is used for electron heating in the positive column region.

Vacuum ultraviolet rays emitting visible light by a collision with the phosphor material are generated when xenon (Xe) gas is transferred from an excitation state to a ground state. The excitation state of xenon (Xe) is generated by a collision between xenon (Xe) gas and electrons. Therefore, in order to raise the ratio of the input voltage used for generating visible light, i.e., the luminescence efficiency, the ratio of the input voltage used for discharging xenon (Xe) gas, i.e., the discharge efficiency, has to be increased. In order to increase the discharge efficiency, the number of collisions between xenon (Xe) gas and electrons has to be increased. In order to increase the number of collisions between xenon (Xe) gas and electrons, the electron heating efficiency must be increased.

In the cathode sheath region, most of the input voltage is consumed, but the electron heating efficiency is low. In the positive column region, the input voltage is hardly consumed, and the electron heating efficiency is very high. The cathode sheath region and the anode sheath region occupy an almost constant space regardless of the distance between the sustain electrodes and the scan electrodes. Therefore, in order to obtain high discharge efficiency, the positive column region has to be increased. In order to increase the positive column region, an opposed discharge structure type of plasma display panel for increasing the distance and opposing area between the sustain electrodes and the scan electrodes is required.

The above information disclosed in this Background section is only for enhancement of understanding of the background of the present embodiments and therefore it may contain information that does not form the prior art that is already known in this country to a person of ordinary skill in the art.

### SUMMARY OF THE INVENTION

The present embodiments provide a plasma display panel having an opposed discharge structure that can improve discharge efficiency by causing an opposed discharge more efficiently by controlling the diffusion of an electric field at edge portions of electrodes in the plasma display panel.

According to one embodiment, a plasma display panel includes: a first substrate and a second substrate arranged to face each other with a predetermined space therebetween, and having a plurality of discharge cells defined in the space between the first and second substrates; phosphor layers formed inside the respective discharge cells; address electrodes formed to extend along a first direction on the second substrate; first and second electrodes formed to extend along a second direction intersecting the first direction, between the first and second substrates, and projecting toward the first substrate in a direction away from the second substrate, the first and second electrodes facing each other with a space therebetween; and third and fourth electrodes formed along the second direction between the first substrate and the second substrate, and separated from the respective first and second electrodes in a direction substantially perpendicular to the second substrate.

Center lines of the third electrodes and center lines of the first electrodes, or center lines of the fourth electrodes and center lines of the second electrodes, may be formed to be consistent with each other.

The respective third and fourth electrodes are arranged closer to the first substrate than the first and second electrodes are.

The third and fourth electrodes are formed as floating electrodes.

In a plasma display panel according to another embodiment, the third or fourth electrodes may be intermittently formed along the second direction, and preferably, the third or fourth electrodes are formed at portions corresponding to the respective discharge cells.

In the above embodiments, the address electrodes may include bus electrodes formed to extend along the first direction while corresponding to the boundaries of the discharge cells neighboring along the second direction and extension electrodes extending toward the center of the respective discharge cells from the bus electrodes. Preferably, the extension electrodes are formed as transparent electrodes.

On cross sections of the first electrodes and of the second electrodes, the length in a direction substantially perpendicular to the second substrate is greater than the length in a direction substantially parallel to the second substrate.

The respective first and second electrodes may be arranged to pass the boundaries of the discharge cells neighboring along the first direction, and disposed in an alternating manner along the first direction. The third and fourth electrodes may be arranged to pass the boundaries of the discharge cells neighboring the discharge cells along the first direction.

The first, second, third, and fourth electrodes may be metal electrodes.

A first dielectric layer may be formed on the outer surfaces of the address electrodes, and a second dielectric layer may be formed on the outer surfaces of the first, second, third, and fourth electrodes. A protective film may be further formed on the outer surfaces of the first and second dielectric layers.

The second dielectric layer includes a first dielectric layer portion formed along the first direction and a second dielectric layer portion formed in a direction intersecting the first dielectric layer portion. A plurality of first discharge spaces are defined by the first and second dielectric layer portions.

Barrier ribs defining a plurality of second discharge spaces facing the first discharge spaces may be formed on the first substrate, and the first and second discharge spaces may form one discharge cell.

In some embodiments, the barrier ribs may include first barrier members formed to extend along the first direction while corresponding to the first dielectric layer portion, and second barrier rib members formed to intersect the first barrier rib members while corresponding to the second dielectric layer portion.

Preferably, the phosphor layers are formed adjacent to the first substrate in the discharge cells.

According to the above-described plasma display panel of the present embodiments, a uniform electric field can be formed between the sustain electrodes and the scan electrodes by providing floating electrodes so as to correspond to the sustain electrodes and the scan electrodes, respectively. Furthermore, by preventing the bending of lines of electric force established at the edge portions of the sustain and scan electrodes, a sustain discharge can be smoothly performed, thereby enhancing discharge efficiency.

Furthermore, since an opposed discharge occurs between the sustain electrodes and the scan electrodes, a long-gap discharge is enabled, so that a higher luminescence efficiency can be achieved as compared to the conventional surface discharge structure.

Furthermore, since the address electrodes are formed on the front substrate, it is possible to prevent the life span of the phosphors from being shortened due to ion sputtering as charges are accumulated on the phosphor layers.

### BRIEF DESCRIPTION OF THE DRAWINGS

FIG. 1 is a partial exploded perspective view showing a plasma display panel according to a first embodiment.

FIG. 2 is a partial plan view schematically showing structures of electrodes and discharge cells in the plasma display panel according to the first embodiment.

FIG. 3 is a partial cross-sectional view taken along the line III-III of FIG. 1 in a state in which the plasma display panel is assembled.

FIG. 4 is a partial cross-sectional view taken along the line IV-IV of FIG. 1 in a state in which the plasma display panel is assembled.

FIG. 5a is a view schematically showing the distribution of lines of electric force established between a sustain electrode and a scan electrode.

FIG. 5b is a view schematically showing lines of electric force established between a sustain electrode and a scan electrodes in an opposed discharge structure to which a first floating electrode and a second floating electrode are added.

FIG. 6 is a partial cross-sectional view of a plasma display panel according to a second embodiment.

### DETAILED DESCRIPTION OF THE PREFERRED EMBODIMENT

The present embodiments will now be described more fully hereinafter with reference to the accompanying drawings, in which preferred embodiments are shown. As those skilled in the art would realize, the described embodiments may be modified in various different ways, all without departing from the spirit or scope of the present embodiments. In the drawings, many of the details of a plasma display panel that are not relevant to the present embodiments will be omitted for the purpose of clarity. Like reference numerals designate like elements throughout the specification.

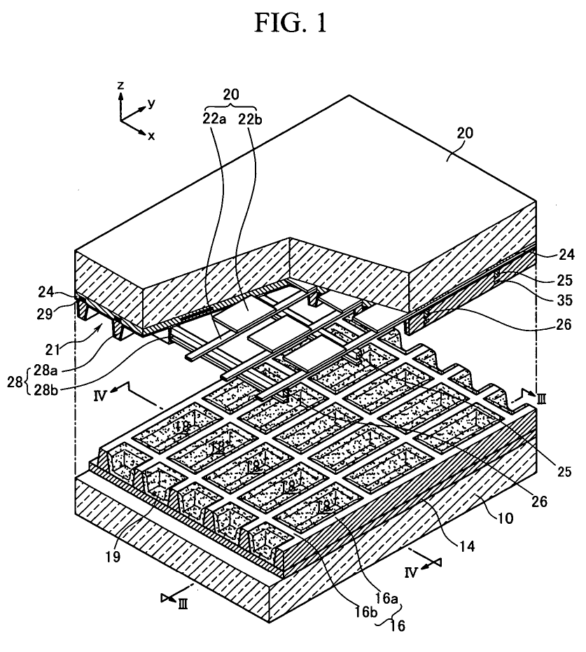

FIG. 1 is a partial exploded perspective view showing a plasma display panel according to a first embodiment.

With reference to FIG. 1 to 4, a PDP of the first embodiment includes a first substrate 10 (hereinafter, referred to as a rear substrate) and a second substrate 20 (hereinafter, referred to as a front substrate) arranged to face each other with a predetermined gap therebetween, and a plurality of discharge cells 17 defined between the rear substrate 10 and the front substrate 20. In the discharge cells 17, phosphor layers 19 are formed so as to absorb ultraviolet rays and to emit visible light. Further, a discharge gas (for example, a mixed gas including Xe, Ne, and the like) is filled into the discharge cells 17 so as to generate a plasma discharge.

Address electrodes 22 are formed on a surface of the front substrate 20 facing the rear substrate 10 to extend along a first direction (hereinafter, referred to as “x-axis direction”). The address electrodes 22 are formed in substantially parallel at a predetermined distance from each other. A first dielectric layer 24 is formed on the front substrate 20 while covering the address electrodes 22. First electrodes 25 (hereinafter, referred to as “sustain electrodes”) and second electrodes 26 (hereinafter, referred to as “scan electrodes”) are formed on the first dielectric layer 24 to extend along a second direction (hereinafter, referred to as “y-axis direction”) intersecting the y-axis direction.

Third electrodes 35 (hereinafter, referred to as “first floating electrodes”) and fourth electrodes 36 (hereinafter, referred to as “second floating electrodes”) are formed in a direction (negative z-axis direction in FIG. 1) substantially perpendicular to the front substrate 20, and separated from the sustain electrodes 25 and the scan electrodes 26. A second dielectric layer 28 is formed on the first dielectric layer 24 while covering the sustain electrodes 25, scan electrodes 26, first floating electrodes 35, and second floating electrodes 36.

The second dielectric layer 28 includes a first dielectric layer portion 28a and a second dielectric layer portion 28b. The first dielectric layer portion 28a is formed to extend along the first direction, and the second dielectric layer portion 28b is formed to extend along the second direction intersecting the first dielectric layer portion 28b. A plurality of first discharge spaces 21 are formed on the first dielectric layer portion 28a and second dielectric layer portion 28b intersecting each other.

A third dielectric layer 14 is formed on a surface of the rear substrate 10 facing the front substrate 20. Barrier ribs 16 defining a plurality of second discharge spaces 18 are formed on the third dielectric layer 14. In this embodiment, although the barrier ribs 16 are formed on the third dielectric layer 14, the barrier ribs 16 may be directly formed on the rear substrate 10 without forming the third dielectric layer 14. Alternatively, the barrier ribs 16 may be formed by etching the rear substrate 10 to correspond to the shapes of the second discharge spaces 18. In some embodiments, the barrier ribs 16 and the rear substrate 10 are made of the same material but the present embodiments are not limited thereto.

The barrier ribs 16 include first barrier rib members 16a and second barrier rib members 16b. The first barrier rib members 16a are formed to extend along the first direction (y-axis direction of the drawing) while corresponding to the first dielectric layer portion 28a, and the second barrier rib members 16b are formed to intersect the first barrier rib members 16a while corresponding to the second dielectric layer portion 28b.

The second discharge spaces 18 are defined by the first barrier rib members 16a and the second barrier rib members 16b. Such a barrier rib structure is not limited to the above-described structure, and a striped barrier rib structure including only barrier rib members substantially parallel with the first direction (y-axis direction of the drawing) may also be applied to the present embodiments, and various shapes of barrier rib structures defining the second discharge spaces are possible. These also fall within the scope of the present embodiments.

The first discharge spaces 21 are defined on the front substrate 20 by the first dielectric layer portion 28a and second dielectric layer portion 28b. The second discharge spaces 18 are defined on the rear substrate 10 by the first barrier rib members 16a and the second barrier rib members 16b. A first discharge space 21 and a second discharge space 18 are formed to face each other to substantially form one discharge cell 17.

Phosphor layers 19 are formed in the discharge cells 17. More specifically, phosphor layers 19 are formed in the second discharge spaces 19 formed on the rear substrate 10. As above, by forming the address electrodes 22 on the front substrate 20 and the phosphor layers 19 on the rear substrate 10, when an address discharge occurs, a discharge firing voltage is uniformly formed for each discharge cell 17.

In the conventional three-electrode surface discharge structure, phosphor layers are formed between the address electrodes and scan electrodes which generate the address discharge, and dielectric constants of the phosphor layers of red, green, and blue colors are different from one another. Therefore, the discharge firing voltage of the address discharge is different according to colors. In the present embodiment, the address electrodes 22 and scan electrodes 26 involved in the address discharge are formed on the rear substrate 10, and the phosphor layers 19 are formed on the front substrate 20, thereby solving the conventional problem.

The address discharge occurs between the address electrodes 22 disposed on the front substrate 20 and the scan electrodes 26 arranged between the front substrate 20 and the rear substrate 10. Thus, at the time of an address discharge, charges are not accumulated on the phosphor layers 19 formed on the rear substrate 10. Thus, it is possible to prevent the life span of the phosphors from being shortened due to ion sputtering as charges are accumulated on the phosphor layers 19.

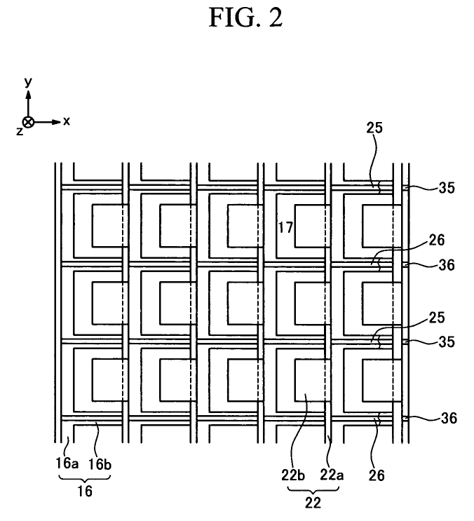

FIG. 2 is a partial plan view schematically showing structures of electrodes and discharge cells in the plasma display panel according to the first embodiment.

Referring to FIG. 2, the address electrodes 22 formed to extend along the first direction (y-axis direction of the drawing) of the second substrate 20 include bus electrodes 22a and extension electrodes 22b. The bus electrodes 22a extend along the first direction (y-axis direction of the drawing) while corresponding to the first barrier rib members 16a, and the extension electrodes 22b extend toward the center of the respective discharge cells 17 from the bus electrodes 22a while corresponding to each discharge cell 17.

In some embodiments, the extension electrodes 22b may be formed as transparent electrodes of, for example, ITO (Indium Tin Oxide), in order to secure the aperture ratio of the front substrate 20. In the present embodiment, the extension electrodes have a rectangular planar shape, and extension electrodes having other planar shapes may also be applicable to the present embodiments. For instance, extension electrodes of a triangular shape, whose width gradually decreases as they get close to the sustain electrodes 25 from the scan electrodes 26, may be applied to the present embodiments. This also falls within the scope of the present embodiments. The bus electrodes 22a may be metal electrodes in order to compensate the high resistance of the transparent electrodes and to improve conductivity. In the present embodiment, the bus electrodes 22a are formed in substantially parallel with each other while passing the boundaries of the discharge cells 17 neighboring in the second direction (x-axis direction of the drawing). Thus, even if they are formed as metal electrodes, the aperture ratio of the front substrate 20 is not lowered.

The sustain electrodes 25 and scan electrodes 26 and the first floating electrodes 35 and second floating electrodes 36 corresponding to the sustain electrodes 25 and scan electrodes 26, respectively, are formed in a direction intersecting the address electrodes 22. In the present embodiment, the sustain electrodes 25 and scan electrodes 26 are formed in an alternating manner along the first direction (y-axis direction of the drawing) while passing the boundaries of the discharge cells 17 neighboring in the first direction (y-axis direction of the drawing). The scan electrodes 26 cause an address discharge during an address period by interaction with the address electrodes 22. Selected discharge cells 17 are turned on by the address discharge. The sustain electrodes 25 cause a sustain discharge during a sustain period mainly by interaction with the scan electrodes 26. Due to the sustain discharge, images are displayed through the front substrate 20. However, they are not limited thereto since their role may differ according to a discharge voltage applied to each electrode.

In the meantime, the first floating electrodes 35 and second floating electrodes 36 are formed to correspond to the sustain electrodes 25 and scan electrodes 26, respectively. That is, the first floating electrodes 35 are formed to extend along the second direction (x-axis direction of the drawing) while passing the boundaries of the discharge cells 17 neighboring in the first direction (y-axis direction of the drawing). In the present embodiment, the first floating electrodes 35 and second floating electrodes 36 are formed to correspond to the sustain electrodes 25 and scan electrodes 26, respectively. Alternatively, only the first floating electrodes 35 may be formed to correspond to the sustain electrodes 25, or only the second floating electrodes 36 may be formed to correspond to the scan electrodes 26. The first floating electrodes 35 are formed to be overlapped with the sustain electrodes 25, and the second floating electrodes 36 are formed to be overlapped with the scan electrodes 26. In other words, a virtual plane including the first floating electrodes 35 and the sustain electrodes 25 or a virtual plane including the second floating electrodes 36 and the sustain electrodes 25 is formed to substantially perpendicularly cross a virtual plane substantially parallel to the front substrate 20. More specifically, referring to FIG. 2, the center line L of the first floating electrodes 35 and the center line L of the sustain electrodes 25 are formed to be consistent with each other in a direction substantially perpendicular to the front substrate 20. The center line of the second floating electrodes 36 and the center line of the scan electrodes 26 are formed to be consistent with each other in a direction substantially perpendicular to the front substrate 20. That is, when viewed from a negative z-axis direction, the sustain electrodes 25 and the first floating electrodes 35 or the scan electrodes 26 and the second floating electrodes 36 are formed to overlap each other.

The sustain electrodes 25, scan electrodes 26, first floating electrodes 35, and second floating electrodes 36 may be formed as metal electrodes. That is, in the present embodiment, since the sustain electrodes 25, scan electrodes 26, first floating electrodes 35, and second floating electrodes 36 are arranged on the boundaries of the discharge cells 17 neighboring in the first direction (y-axis direction of the drawing), deterioration of the aperture ratio can be prevented even if these electrodes are formed of metal.

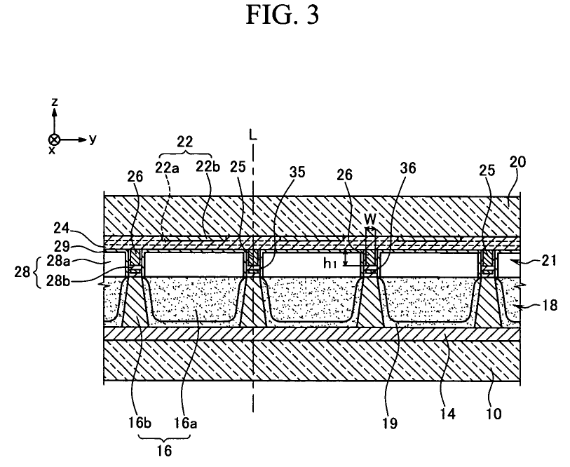

FIG. 3 is a partial cross-sectional view taken along the line III-III of FIG. 1 in a state in which the plasma display panel is assembled.

Referring to FIG. 3, the sustain electrodes 25 and the scan electrodes 26 are formed on the first dielectric layer 24 covering the address electrodes 22. The sustain electrodes 25 and the scan electrodes 26 project toward the rear substrate 10 in a direction away from the front substrate 20 and face each other with a space therebetween. Cross-sections of the sustain electrodes 25 and scan electrodes 26 may be formed in a manner such that the length h1 in a direction (z-axis direction) substantially perpendicular to the substrates 10 and 20 is greater than the width W in a direction substantially parallel to the substrates 10 and 20. In other words, the height of the sustain electrodes 25 and scan electrodes 26 from a surface of the front substrate 20 may be greater than their width. By thus increasing the height of the sustain electrodes 25 and scan electrodes 26, even when the planar-direction size of the discharge cells has to be decreased in order to achieve a high-definition display, the decrease in size can be compensated. Additionally, by increasing the area of the opposing surface between the sustain electrodes 25 and the scan electrodes 26, a higher luminescence efficiency can be achieved in comparison with a surface discharge structure.

The first floating electrodes 35 and the second floating electrodes 36 are arranged to be separated from the sustain electrodes 25 and the scan electrodes 26 in a direction substantially perpendicular to the front substrate 20. The second dielectric layer 28 is formed between the first floating electrodes 35 and the sustain electrodes 25 and between the second floating electrodes 36 and the scan electrodes 26. That is, the second dielectric layer 28 is formed on the outer surfaces of the sustain electrodes 25, scan electrodes 26, first floating electrodes 35, and second floating electrodes 36. The second dielectric layer 28 and the first dielectric layer 24 covering the address electrodes 22 may be made of the same material, and play a role of protecting each of the electrodes from a collision with charges generated at the time of gas discharge. At the time of address discharge, wall charges may be accumulated on the first dielectric layer 24 and the second dielectric layer 28. The thus accumulated wall charges play the role of reducing a discharge firing voltage when there is a sustain discharge between the sustain electrodes 25 and the scan electrodes 26.

A protective film 29 may be further formed on the outer surfaces of the first dielectric layer 24 and second dielectric layer 28. Preferably, the protective film is formed in portions of the outer surfaces of the dielectric layers that are exposed to a gas discharge. As an example of the protective film 29, an MgO protective film 29 can be used. The MgO protective film 29 plays a role of protecting the dielectric layers from collision with ions ionized in the gas discharge. The MgO protective film 29 has a high secondary electron emission coefficient upon collision with ions, thereby increasing discharge efficiency.

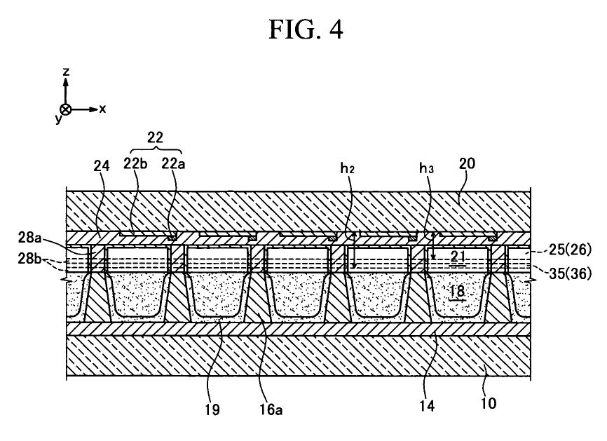

FIG. 4 is a partial cross-sectional view taken along the line IV-IV of FIG. 1 in a state in which the plasma display panel is assembled.

Referring to FIG. 4, the distance h2 between the first floating electrodes 35 and second floating electrodes 36 and the front substrate 20 is longer than the distance h3 between the sustain electrodes 25 and scan electrodes 26 and the front substrate 20. That is, in a direction (z-axis direction of the drawing) substantially perpendicular to the front substrate 20, the first floating electrodes 35 and the second floating electrodes 36 are arranged to be separated farther from the front substrate 20, where the address electrodes 22 are formed, than the sustain electrodes 25 and the scan electrodes 26 are, respectively. More specifically, the first floating electrodes 35 and the second floating electrodes 36 are arranged closer to the rear substrate 10 than the sustain electrodes 25 and the scan electrodes 26 are, respectively. The first floating electrodes 35 and the second floating electrodes 36 play the role of controlling the diffusion of an electric field formed between the sustain electrodes 25 and the scan electrodes 26 at the time of a sustain discharge. That is, an electric field that is biased towards the phosphor layers 19 is formed at edge portions of the sustain electrodes 25 and of the scan electrodes 26 that are adjacent to the rear substrate 10. When the diffusion of the electric field occurs with this configuration, discharge efficiency is reduced at the time of a sustain discharge between the sustain electrodes 25 and the scan electrodes 26.

However, in the present embodiment, the first floating electrodes 35 are provided to correspond to the sustain electrodes 25, and the second floating electrodes 36 are provided to correspond to the scan electrodes 26. Due to this, the electric field formed between the boundaries of the sustain electrodes 25 and the boundaries of the scan electrodes 26 is controlled, and the diffusion of the electric field is minimized. Additionally, the discharge between the sustain electrodes 25 and the scan electrodes 26 is smoothly performed, thereby enhancing discharge efficiency.

In the present embodiment, due to the structure in which the address electrodes 22 are formed on the front substrate 20, the first floating electrodes 35 and the second floating electrodes 36 are arranged closer to the rear substrate 10 than the sustain electrodes 25 and the scan electrodes 26 are. However, in a structure where the address electrodes 22 are formed on the rear substrate 10, the first floating electrodes 35 and the second floating electrodes, respectively, can be arranged closer to the front substrate 20 than the sustain electrodes 25 and the scan electrodes 26 are. This also falls within the scope of the present embodiments.

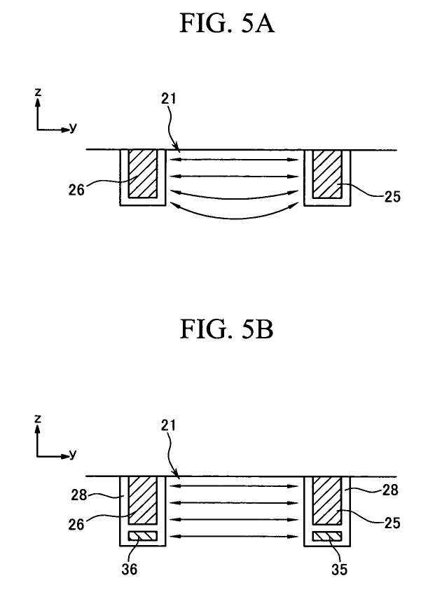

FIGS. 5a and 5b are views schematically showing the distribution of lines of electric force established between a sustain electrode and a scan electrode.

FIG. 5a schematically shows the distribution of lines of electric force established between a sustain electrode and a scan electrode in a structure where no floating electrodes are provided. FIG. 5b schematically shows the distribution of lines of electric force established between a sustain electrode and a scan electrode in a structure where floating electrodes are provided.

With reference to these drawings, the role to be performed by the floating electrodes during a sustain discharge will be described in detail. Referring to FIG. 5a, as described above, no uniform electric field is formed between the edge portions of the sustain electrodes 25 and the edge portions of the scan electrodes 26, and the bending of lines of electric force occurs. That is, the lines of electric force are formed so as to be far from the first discharge spaces 21 where a discharge is substantially fired. Due to this, the number of lines of electric force passing through the unit area is reduced on the edge portions of the sustain electrodes 25 and the edge portions of the scan electrodes 26, and accordingly the intensity of an electric field is reduced and the electric field becomes non-uniform.

Referring to FIG. 5b, the first floating electrodes 35 and the second floating electrodes 36 are arranged in the second dielectric layer 28 covering the sustain electrodes 25 and the scan electrodes 26. The first floating electrodes 35 and the second floating electrodes 36 are arranged to be separated from the sustain electrodes 25 and the scan electrodes 26 in a negative z-axis direction, and no external voltage is applied to the first floating electrodes 35 and the second floating electrodes 36.

In some embodiments, when a voltage is applied to the sustain electrodes 25 and the scan electrodes 26, a floating potential occurs at the first floating electrodes 35 and the second floating electrodes 36. The lines of electric force between the edges of the sustain electrodes 25 and the edges of the scan electrodes 26 are affected by the floating potential to rise toward the first discharge spaces 21. That is, the lines of electric force between the edge portions of the sustain electrodes 25 and the edge portions of the scan electrodes 26 are concentrated toward the first discharge spaces 21. As the lines of electric force are concentrated toward the first discharge spaces 21, a uniform electric field is formed between the edges of the sustain electrodes and the edges of the scan electrodes 26, and a smooth sustain discharge occurs.

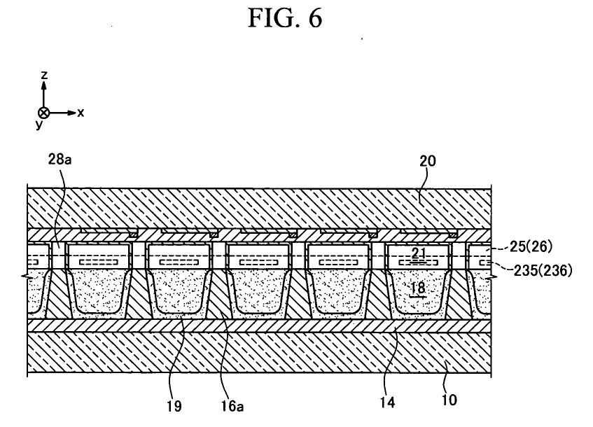

FIG. 6 is a partial cross-sectional view of a plasma display panel according to a second embodiment. The configuration of the second embodiment is generally similar or identical to that of the first embodiment, and a detailed description of identical parts will be omitted and description will be given of different parts.

Referring to FIG. 6, in a plasma display panel according to the second embodiment, first floating electrodes 235 and second floating electrodes 236 are intermittently formed along the second direction (x-axis direction of the drawing). More specifically, the first floating electrodes 235 and the second floating electrodes 236 are formed at portions corresponding to the first discharge spaces 21, but are not formed at portions intersecting the first dielectric layer portion 28a. That is, the first floating electrodes 235 and the second floating electrodes 236 are formed in the first discharge spaces 21 where a discharge is substantially fired. Due to this, an electric field is uniformly formed in the first discharge spaces 21, so the cost of electrode materials can be reduced and the bending of lines of electric force established between the edge portions of the sustain electrodes 25 and the edge portions of the scan electrodes 26 can be efficiently controlled.

While these embodiments have been described in connection with what is presently considered to be practical exemplary embodiments, it is to be understood that the embodiments are not limited to the disclosed embodiments, but, on the contrary, is intended to cover various modifications and equivalent arrangements included within the spirit and scope of the appended claims.

What is claimed is:

1. A plasma display panel, comprising:
a first substrate and a second substrate arranged to face each other with a predetermined space therebetween;
a plurality of discharge cells defined in the space between the first and second substrates;
phosphor layers formed inside the respective discharge cells;
address electrodes formed to extend along a first direction on the second substrate;
first and second electrodes formed to extend along a second direction intersecting the first direction, between the first and second substrates, and projecting toward the first substrate in a direction away from the second substrate, the first and second electrodes facing each other with a space therebetween; and
third and fourth electrodes formed along the second direction between the first substrate and the second substrate, and separated from the respective first and second electrodes in a direction substantially perpendicular to the second substrate.

2. The plasma display panel of claim 1, wherein center lines of the third electrodes and center lines of the first electrodes, or center lines of the fourth electrodes and center lines of the second electrodes, are aligned with a line substantially perpendicular to the first and second substrate.

3. The plasma display panel of claim 1, wherein the third and fourth electrodes are closer to the first substrate than a distance between the first and second electrodes and the first substrate.

4. The plasma display panel of claim 1, wherein the third and fourth electrodes are formed as floating electrodes.

5. The plasma display panel of claim 1, wherein the third or fourth electrodes are intermittently formed along the second direction.

6. The plasma display panel of claim 5, wherein the third or fourth electrodes are formed at locations corresponding to the respective discharge cells.

7. The plasma display panel of claim 1, wherein the address electrodes comprise: bus electrodes formed to extend along the first direction in locations corresponding to boundaries between neighboring discharge cells, the neighboring discharge cells being adjacent in the second direction; and extension electrodes extending toward the center of the respective discharge cells from the bus electrodes.

8. The plasma display panel of claim 7, wherein the extension electrodes are formed as transparent electrodes.

9. The plasma display panel of claim 1, wherein the length of the first electrodes and of the second electrodes in a direction substantially perpendicular to the second substrate is greater than the length of the first electrodes and of the second electrodes in a direction substantially parallel to the second substrate.

10. The plasma display panel of claim 1, wherein the respective first and second electrodes are arranged to span the boundaries of the neighboring discharge cells along the first direction, and are disposed along every other boundary.

11. The plasma display panel of claim 10, wherein the third or fourth electrodes are arranged to span the boundaries of the neighboring discharge cells along the first direction.

12. The plasma display panel of claim 11, wherein the first, second, third, and fourth electrodes are metal electrodes.

13. The plasma display panel of claim 1, wherein a first dielectric layer is formed on the outer surfaces of the address electrodes, and a second dielectric layer is formed on the outer surfaces of the first, second, third, and fourth electrodes.

14. The plasma display panel of claim 13, wherein a protective film is formed on the outer surfaces of the first and second dielectric layers.

15. The plasma display panel of claim 13, wherein the second dielectric layer includes a first dielectric layer portion formed along the first direction and a second dielectric layer portion formed in a direction intersecting the first dielectric layer portion, and
a plurality of first discharge spaces defined by the first and second dielectric layer portions.

16. The plasma display panel of claim 1, wherein barrier ribs defining a plurality of second discharge spaces facing the first discharge spaces are formed on the first substrate, and the first and second discharge spaces collectively form discharge cells, each discharge cell being formed by a single first and a single second discharge space.

17. The plasma display panel of claim 16, wherein the barrier ribs comprise first barrier members formed to extend along the first direction and to correspond to the first dielectric layer portion, and
second barrier rib members formed to intersect the first barrier rib members and to correspond to the second dielectric layer portion.

18. The plasma display panel of claim 1, wherein the phosphor layers are formed adjacent to the first substrate in the discharge cells.
